(19) United States
(12) Patent Application Publication
(10) Pub. No.: US 2016/0323408 A1
(43) Pub. Date: Nov. 3, 2016

(54) CACHING IN A MOBILE NETWORK

(71) Applicant: Google Inc., Mountain View, CA (US)

(72) Inventors: Bok Knun Randolph Chung, Los Altos, CA (US); Ankur Jain, Mountain View, CA (US); Dutt Kalapatapu, Santa Clara, CA (US); Hassan Sipra, San Jose, CA (US)

(21) Appl. No.: 15/130,454

(22) Filed: Apr. 15, 2016

Related U.S. Application Data
(60) Provisional application No. 62/155,894, filed on May 1, 2015.

(51) Int. Cl. H04L 29/08

(52) U.S. Cl. CPC H04L 67/2842; H04L 67/1097; H04L 67/1004

(57) ABSTRACT

Systems and methods for providing data caching within a mobile access network include deploying data cache(s) in association with one or more network nodes configured to manage communications between the mobile access network and external data networks. Upon a content provider network receives a data request from a client device via the mobile access network, the content provider network can determine whether the requested data is cached in one of the network nodes managing communications with the content provider network. If a network node is determined, the content provider network can redirect the client device to the determined network node. The client device can then request the data from the determined network node. The network node can determine a caching server storing the requested data and redirecting the client device to the caching server.

### CROSS REFERENCE TO RELATED APPLICATIONS

This application claims priority to U.S. Provisional Patent Application No. 62/155,894, filed on May 1, 2015, and entitled “Caching In Mobile Network.” The entirety of the aforementioned application is hereby incorporated by reference herein.

### FIELD OF THE DISCLOSURE

The present disclosure relates generally to the field of data delivery via a communications network.

### BACKGROUND

The present invention relates generally to the field of content delivery via a communications network. As more users are switching to (or more often using) mobile networks, the amount of data traffic served through mobile networks is skyrocketing.

### SUMMARY

According to at least one aspect of this disclosure, an apparatus associated with a mobile access network is configured to handle connections with a content provider network and to managing access to data cache associated with the content provider network and deployed within the mobile access network. The apparatus includes at least one processor and at least one memory storing computer code instructions. The computer code instructions when executed by the at least one processor can cause the apparatus to receive a request for data associated with the provider network. The request associated with a client device in communication with the mobile access network. The computer code instructions can also cause the apparatus to obtain at least one attribute of the mobile access network and determine a caching server deployed in the mobile access network for serving the request for data. The caching server can be determined based on information associated with the request and the at least one attribute. The computer code instructions can also cause the apparatus to redirect the client device to the determined caching server.

According to at least one aspect of this disclosure, a method for managing data associated with a content provider network cached within a mobile access network is performed by an integrated gateway and caching node of the mobile access network. The integrated gateway and caching node is configured to handle communications with content provider networks and manage content provider data cached in the mobile access network, the method comprising. The method can include receiving a request for data generated by a client device in communication with the mobile access network, obtaining at least one communication attribute associated with the mobile access network, and determining a caching server deployed in the mobile access network for serving requested data to the client device. The caching server can be determined based on information associated with the request and the at least one attribute. The method can also include redirecting the client device to the determined caching server.

According to at least one aspect of this disclosure, a computer-readable medium includes computer code instructions stored thereon, which when executed by a processor can perform a method for managing data associated with a content provider network and cached within a mobile access network. The method can include receiving, at an integrated gateway and caching node of the mobile access network, a data request generated by a client device in communication with the mobile access network. The integrated gateway and caching node is configured to handle communications with content provider networks and manage content provider data cached in the mobile access network. The method can include obtaining at least one communication attribute associated with the mobile access network and determining a caching server deployed in the mobile access network for serving requested data to the client device. The caching server can be determined based on information associated with the request and the at least one attribute. The method can also include redirecting the client device to the determined caching server.

According to at least one aspect of this disclosure, an apparatus associated with a content provider network includes at least one processor and at least one memory storing computer code instructions. The computer code instructions when executed by the at least one processor can cause the apparatus to perform a method for managing access to data associated with the content provider network. The method can include receiving a data request, from a client device, for data associated with the content provider network through a mobile access network. The method can include determining based on information associated with the request a network node of the mobile access network associated with a data cache storing the requested data. The network node is configured to handle communications between mobile access network and the content provider network and to manage access to data associated with the content provider network cached within the mobile access network. The method can include redirecting the client device to the network node and receiving a caching server request, from the network node, for a caching server to serve the requested data. The caching server request can include at least one attribute of the mobile access network The method can also include determining a caching server deployed in the mobile access network for serving the request for data. The caching server can be determined based on information associated with the request and the at least one attribute. The method can also include sending an indication of the caching server to the network node.

According to at least one aspect of this disclosure, a method for managing access to data associated with a content provider network is performed by an apparatus associated with content provider network. The method can include receiving a data request, from a client device, for data associated with the content provider network through a mobile access network. The method can include determining based on information associated with the request a network node of the mobile access network associated with a data cache storing the requested data. The network node is configured to handle communications between mobile access network and the content provider network and to manage access to data associated with the content provider network cached within the mobile access network. The method can include redirecting the client device to the network node and receiving a caching server request, from the network node, for a caching server to serve the requested data. The caching server request can include at least one attribute of the mobile access network. The method can also include determining a caching server deployed in the mobile access network for serving the request for data. The caching server can be determined based on information associated with the request and the at least one attribute. The method can also include sending an indication of the caching server to the network node.

According to at least one aspect of this disclosure, a computer-readable medium includes computer code instructions stored thereon, which when executed by a processor can perform a method for managing access to data associated with a content provider network. The method can include receiving a data request, from a client device, for data associated with the content provider network through a mobile access network. The method can include determining based on information associated with the request a network node of the mobile access network associated with a data cache storing the requested data. The network node is configured to handle communications between mobile access network and the content provider network and to manage access to data associated with the content provider network cached within the mobile access network. The method can include redirecting the client device to the network node and receiving a caching server request, from the network node, for a caching server to serve the requested data. The caching server request can include at least one attribute of the mobile access network The method can also include determining a caching server deployed in the mobile access network for serving the request for data. The caching server can be determined based on information associated with the request and the at least one attribute. The method can also include sending an indication of the caching server to the network node.

### BRIEF DESCRIPTION OF THE DRAWINGS

The above and related objects, features, and advantages of the present disclosure will be more fully understood by reference to the following detailed description, when taken in conjunction with the accompanying figures, wherein:

FIG. 1 shows a block diagram illustrating an example communication environment for serving mobile devices with content associated with a content provider;

FIG. 2 shows a block diagram illustrating example functional components associated with an example integrated gateway and caching node; and

FIG. 3 shows a sequence diagram illustrating an example process of serving a user with data cached in a mobile access network.

For purposes of clarity, not every component may be labeled in every figure. The drawings are not intended to be drawn to scale. Like reference numbers and designations in the various figures indicate like elements.

### DETAILED DESCRIPTION

Increasing numbers of mobile users and increasing mobile data traffic call for continuous and costly investments in network infrastructure by mobile network operators. With continuous improvements in mobile devices and mobile network infrastructure, mobile users are more frequently accessing content provider data through mobile devices. In order to maintain high quality services for users, transport links between mobile access networks and content provider networks need to provide high bandwidth and be continuously operational. However, even with state of the art networks, these links can often become bottlenecks due to the high traffic volume, which can result in a degraded experience for their users.

One of the ways to address the degradation in service due to communication links between content provider networks and mobile access networks is to deploy caching repositories for caching content provider data within a mobile access network. When caching content provider data within a mobile access network, different factors are to be considered, including caching costs to network operators and content providers, added complexity to the mobile access network, and the quality of service associated with cache requests handled within the mobile access network. In this disclosure, methods and systems for caching content provider data in association with gateways, or other portions of a mobile access network, configured to handle communications with external data networks are described.

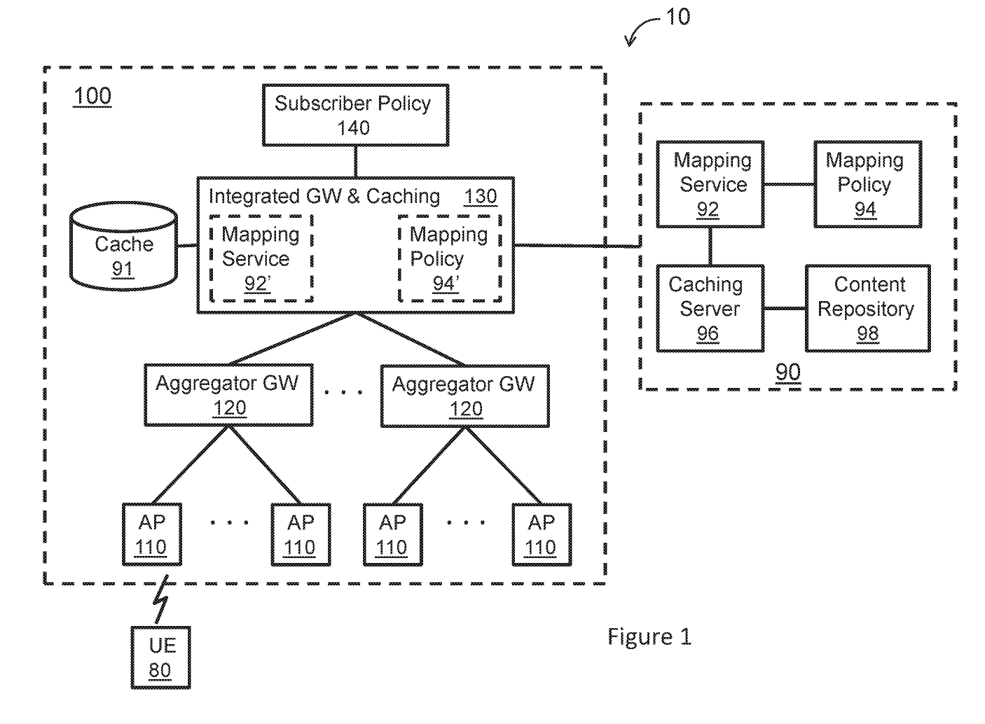

FIG. 1 shows a block diagram illustrating an example communication environment 10 for serving mobile devices with content associated with a content provider. The communication environment 10 includes a content provider network 90 and a mobile access network 100 serving one or more user equipments (UEs) 80. The content provider network 90 includes a mapping service module 92, a mapping policy module 94, a caching server 96 and a caching repository 98. The mobile access network 100 includes a subscriber policy module 140, an integrated gateway and caching network element (or integrated gateway and caching node) 130, a cache repository 91, a plurality of aggregator gateways (or aggregator nodes) 120, and a plurality of access points (APs) 110 for communicating with UEs 80.

The UE 80 can include a mobile phone, smart phone, tablet, laptop, smart watch, wearable item with communications capabilities, audio playing device (such as an MP3 player), video playing device, gaming device, global positioning system (GPS) device, or any other client device capable of communicating with the mobile access network 100. The UE 80 can attach to the mobile access network 100 via wireless links at one of the respective access points 110. In some implementations, the UE 80 is configured to request and access content associated with the content provider network 90 via the mobile access network 100. For instance, an application (such as a browser, media player, game application/platform, email application, enterprise application, social media applications, or the like) running on the UE 80 can request content associated with the content provider network 90 for display on a screen of the UE 80.

The mobile access network 100 can include a WiFi hotspot network, universal mobile telecommunications system (UMTS) network, long-term evolution (LTE) network, any other mobile communication network, or a heterogeneous mobile access network supporting two or more radio access technologies (RATs). The mobile access network 100 can have a hierarchical structure including multiple levels or layers. The layers can include an access point layer including the access points 110, an aggregation layer including the aggregator gateways 120 and an IP management and data caching layer including one or more integrated gateway and caching network nodes 130.

The access points 110 are configured to communicate with UEs 80 via a wireless link. Examples of access points 110 include WiFi access points, NodeBs in a UMTS network, enhanced NodeBs (eNodeBs) in a LTE network or a combination thereof in a heterogeneous network. In some implementations, access points 110 can be distributed geographically and each access point 110 can be configured to serve UEs 80 in a respective geographical neighborhood. As a UE 80 in communication with the mobile access network 100 moves from one geographical location to another, the respective wireless connection to the mobile access network 100 can be transferred (or handed over) from one access point 110 to another based on the proximity of the UE 80 to distinct access points 110.

Each aggregator gateway 120 can be arranged to serve a respective subset of the plurality of access points 110. The aggregator gateway 120 can be configured to handle routing and forwarding of user data packets to and from the respective subset of access points 110. The aggregator gateway 120 can be configured to act as a mobility anchor for the user plane during handovers between different access points 110 in the same mobile access network or handovers between different radio access networks. Examples of aggregator gateways 120 can include serving general packet radio service (GPRS) support nodes (SGSNs), e.g., when the mobile access network is a UMTS network, or serving gateways (SGWs) as used in a LTE network.

The integrated gateway and caching node 130 can include, or be communicatively coupled to, a caching repository 91 for caching content provider data associated with at least one external data network. For instance, content provider data associated with the content provider network 90 can be cached in the caching repository 91. The caching repository 91 can include one or more caching servers deployed within the mobile access network, e.g., in proximity to the integrated gateway and caching node 130, for caching data associated with one or more content provider networks. The integrated gateway and caching node 130 can be configured to manage serving of the data cached in the caching repository 91. The integrated gateway and caching node 130 can also be configured to manage connections between the mobile access network 100 and external data networks such as the Internet or the content provider network 90. For instance, in the case in which the mobile access network 100 is a LTE network, the integrated gateway and caching node 130 can be configured to handle functionality associated with a packet data network gateway (P-GW) and functionality associated with accessing the caching repository 91. In the case in which the mobile access network 100 is a UMTS network, the integrated gateway and caching node 130 can be configured to handle functionalities associated with a gateway GPRS support node (GGSN) and functionalities associated with accessing the caching repository 91.

In some implementations, the integrated gateway and caching node 130 can be implemented as a single network element, such a computer server device or a server rack. In some implementations, the integrated gateway and caching node 130 can be implemented as a system including a plurality of electronic devices arranged in proximity to each other and communicatively coupled to each other. In some implementations, the integrated gateway caching node 130 can be implemented as special logic purpose circuitry such as a field programmable gate array (FPGA) or an application specific integrated circuit (ASIC). In some implementations, the integrated gateway and caching node 130 can be implemented as software, hardware or a combination thereof. The mobile access network 100 can include a plurality of integrated gateway caching nodes 130. In some implementations, each integrated gateway caching node can be associated with a respective caching repository 91 for caching content provider data. In some implementations, distinct caching repositories 91 can cache the same data allowing for caching redundancy. In some implementations, data cached in one caching repository 91 can different from data cached in another caching repository 91.

The integrated gateway caching node 130 can be coupled to (or in communication with) subscriber policy module 140. The subscriber policy module 140 can be a software component or a network element of the mobile access network 100 configured to access subscriber databases and/or specialized functions (such as application functions associated with external data networks) to retrieve subscriber policies or dynamic session information for controlling traffic flows associated with a subscriber or a session. Subscriber policies can include indication(s) of one or more of services allowed (e.g., an indication of a service plan) for a user, a maximum bandwidth supported for the user and charging policies (e.g., prepaid or postpaid). In some implementations, subscriber policies can include policies (or rules) defined for particular types of data flows. For instance, one or more policies can be specific to data flows associated with a given source IP address, destination IP address, communication protocol (e.g., HTTP, FTP, RTP, RTSP, etc.), application type (e.g., YouTube, Facebook, Skype, etc.) or a combination thereof.

Implementations of the subscriber policy module 140 can include the policy and charging rules function (PCRF) used in LTE networks or the authentication, authorization and accounting (AAA) server. The subscriber policy module can be a computer server (or a software module running on one or more computer servers) configured to make policy (or charging) decisions for a given traffic flow associated with a user, session, application, content provider or a combination thereof. The subscriber policy module can be configured to send the determined policy (or charging) decisions to the integrated gateway and caching node 130 for enforcing. The integrated gateway and caching node 130 can include a module (such as the policy and charging enforcement function (PCEF) employed in P-GWs of LTE networks) to enforce decisions signaled by the subscriber policy module 140.

The content provider network 90 can be a data network (or a subnetwork thereof) for providing data (such as data associated with webpages, social media services, gaming services, multimedia services, online shopping services, online application stores or other online services) to users via one or more communication networks such as the mobile access network 100. The content provider network 90 can include the Internet, an IP service network, a data network associated with an online service, one or more datacenters, or the like. The content network 90 can include a plurality of computer servers (or a plurality of server racks) for storing and managing data associated with the content provider network 90. The computer servers of the content provider network 90 can be geographically distributed, for instance, over a plurality of data centers. Each data center can be coupled via communication links to the mobile access network 100.

The content provider network 110 can include a plurality of caching servers 96 configured to manage content provider data and process data requests (e.g., requests generated by UEs 80 and received from the integrated gateway and charging node 130). Data associated with caching servers 96 can vary from one caching server to another. In some implementations, some content can be redundantly stored and copies of the content can be managed by two or more caching servers 96. When a data request is received at the content provider network 90, the request is directed to a proper caching server 96 for serving the requested data. The caching server 96 receiving the request can retrieve the requested content data from a respective content repository 98 and send the retrieved content data to the requesting UE 80. The content repository 98 can be a storing device configured to store data managed by the respective caching server 96.

The content provider network 90 includes a mapping policy module (or database) 94 for maintaining a mapping policy (or rules) or information used to map data requests to caching servers 96. The mapping policy module 94 can maintain information including at least one of a quality of service associated with communication path(s) between the UE 80 and one or more caching servers 96, available connection paths between the mobile access network 100 and the caching servers, commercial policies (e.g., indicative of preferred serving paths), states of the caching servers 96 or a combination thereof. Information indicative of quality of service of a communication path between the UE 80 and a caching server 96 can include indication(s) of a respective bandwidth, latency, packet drop rate, access point congestion state or a combination thereof. Information indicative of available connection paths between the mobile access network 100 and a given caching server can include an indication of whether the caching server is deployed in the content provider network 90 or within the mobile access network, relative capacities and costs of the connection paths, latency of each connection path, state of connection path or a combination thereof. Information indicative of a state of a give caching server can include available CPU or network capacity, state of content available in the cache (e.g., up to date or outdated) or a combination thereof.

The content provider network 90 can include a mapping service module 92 configured to map received data requests to a caching server 96 for processing. The mapping service module can be implemented as a computer server or a software module running on one or more computer servers. Upon a user request for content data arrives to the content provider network 90, the mapping service module 92 is configured to determine a caching server for providing the respective requested content data to the requesting UE 80. The mapping service module 92 can be configured to select the caching server based on at least one of an attribute of the UE 80 or a user thereof (such as a respective IP address) and information obtained from the mapping policy module 94 (such mapping rules and mapping criteria information).

For instance, based on information obtained from the mapping policy module and information associated with the received data request, the mapping service module 92 can identify one or more caching servers associated with the requested content data. The mapping service module 92 can compare states of the identified caching servers and compare the expected quality of service for communication paths between the UE 80 and the identified caching servers. The mapping service module 92 can determine whether the requested content data is cached in the mobile access network 100. The mapping service module 92 can evaluate or compare connections between the mobile access network 100 the identified caching servers. The mapping service module 92 can also check for any commercial policies (e.g., preference(s) of a given communication path or a given caching repository). The mapping service module 92 can then select a caching server among the identified caching servers based on the processed information from the mapping policy module 94 and information obtained from mobile access network 100. The mapping service module 92 can select a caching server 96 deployed within the content provider network 90 or a caching server deployed within the mobile access network 100.

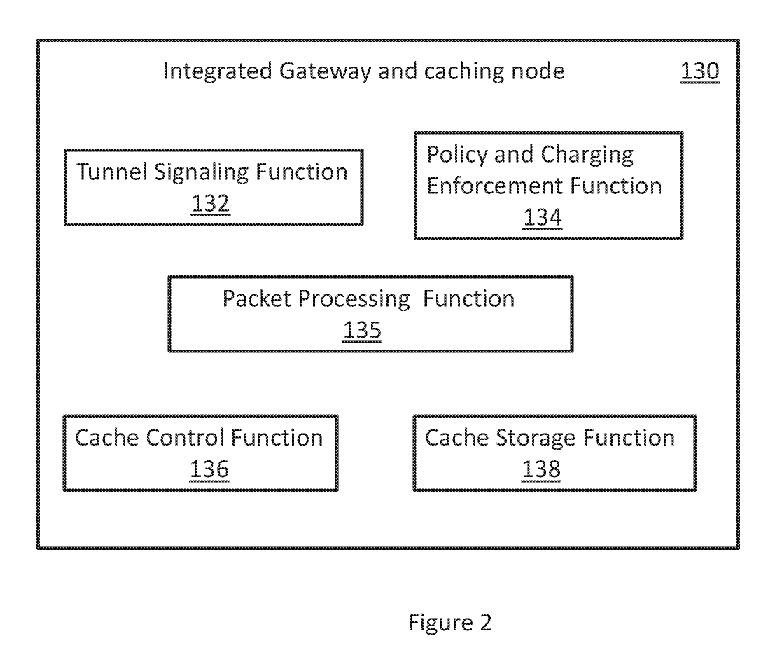

FIG. 2 shows a block diagram illustrating example functional components associated with the integrated gateway and caching node 130. The integrated gateway and caching node 130 can include a tunnel signaling function module 132, a policy and charging enforcement function (PCEF) module 134, a packet processing function 135, a cache control function module 136 and a cache storage function module 138. Each of these function modules can implemented as a software module, hardware module, logic module or a combination thereof.

The tunnel signaling function module 132 can be configured to handle establishment of communication tunnels with aggregator gateways 120 or other network elements. The tunnel signaling function module 132 can be configured to send, receive, or process control messages for establishing communication tunnels. For instance, in a LTE network, the tunnel signaling function module 132 handles GTP-C signaling messages over the S5/S8 and S11 interfaces.

The policy and charging enforcement function (PCEF) module 134 can be configured to receive and enforce policy and charging requests from the subscriber policy module or an online (or offline) charging system. The PCEF module 134 can provide the subscriber policy module 140 with subscriber and access information. For instance, for dynamic policies, the PCEF module 134 can act upon messages received from the subscriber policy module 140 to install, modify, or remove policy and charging control rules. In some implementations, static policies (or rules) can be maintained and enforced by the PCEF module 134 without interaction with the subscriber policy module 140. The PCEF module 134 can enforce policy rules, for instance, by interacting with the packet processing function module 135.

The packet processing function module 135 can be configured to receive data packets from the access network 100 or the provider content network 90 and associate the data packets with respective user session(s). The packet processing function module 135 can be configured to apply policy rules (e.g., from the PCEF module 134), network address translation (NAT) or a combination thereof to a data packets associated with a respective user session. The packet processing function module 135 can then send the processed data packets to the next destination (e.g., the provider network 90 or an aggregator gateway 120).

In some implementations, the packet processing function module 135 is configured to identify data packets that are destined to a cache deployed within the mobile access network 100 or the cache control function module 136. For instance, the packet processing function module 135 can perform a deep inspection of a data packet to retrieve a respective inner destination IP address and determine whether the retrieved IP address corresponds to the cache control function module 136. If the retrieved inner IP address corresponds to the cache control function module 136, the packet processing function module 135 can redirect the data packet to the cache control function module 136.

The cache storage function module 138 can be configured to manage content data stored in a local cache(s) (e.g., repository 91) deployed in association with the integrated gateway and cache node 130. The cache storage function module 138 can be configured to determine what data is to be stored in the cache by employing cache admission and/or cache eviction algorithms. The cache storage function module 138 can maintain a data structure (e.g., a lookup table) to keep track of data stored in the cache, status of the stored data (e.g., out of date or up to date), last time stored data was refreshed or a combination thereof. The cache storage function module 138 can also be configured to communicate information indicative of data stored in the cache or status thereof to the cache control function 136 or to the content provider network 90 (shown in FIG. 1).

The cache control function module 136 can be configured to receive a user request for content data and determine whether the requested content data is cached in the mobile access network 100 (e.g., within the caching repository 91). The cache control function module 138 can determine whether the requested content data is cached within the caching repository 91 by consulting the cache storage function module 138. In response, the cache storage function module 138 can provide the requested content data (or an identification of a cache storing the requested content data), if it is cached in the caching repository 91. The cache control function module 136 can then send the requested content data to the requesting UE 80. The content data can be processed be the packet processing function (i.e., to add proper headers) before sending the UE 80. If the requested content data is not available in a local cache (e.g., caching repository 91), the cache control function module 136 can forward the request to the content provider network 90 (or a caching server thereof).

The cache control function module 136 can be configured to assist in enforcing policies and providing differentiated charging functions in cooperation with the PCEF module 134. For instance, if a policy specifies a specific bandwidth for the requesting UE 80, the cache control function module 136 can select an instance of the requested content data with a bit rate consistent with the specified bandwidth. For multimedia data (such as audio or video data), the cache control function module 136 can select a version of the requested content data with a bitrate consistent with the specified bandwidth, cause such version to be generated (e.g., by initiating an encoder/decoder module to generate the requested content data at a given bitrate) or adapt the data packet transmission rate to comply with specified bandwidth. In cases where the content data provided for sending to the UE 80 is associated with a higher bitrate than the specified bandwidth, respective data packets can be dropped by the mobile access network 100 resulting in degraded multimedia data quality at the UE 80 and, therefore, unsatisfactory user experience. The cache control function module 136 can be configured to rate distinct types of data traffic differently to allow for implementation of differentiated charging functions.

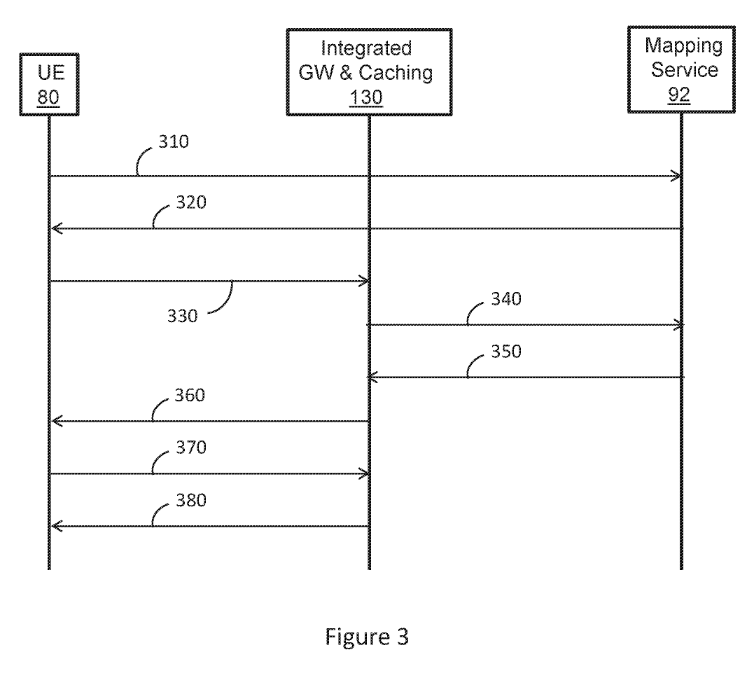

FIG. 3 shows a sequence diagram illustrating an example process 300 of serving a UE with data cached in a mobile access network. Referring to FIGS. 1-3, the process 300 can include the mapping service module 92 receiving a request for content data from a UE 80 (stage 310) and redirecting the UE to a an integrated gateway and caching node 130 (stage 320). The process 300 can include the UE 80 sending a request for the content data to the integrated gateway and caching node 130 (stage 330) and the integrated gateway and caching node 130, in response, sending a request for a caching server to the mapping service module 92 (stage 340). The process 300 can include the mapping service module 92 responding to the integrated gateway and caching node 130 with an identification of a caching server deployed in the mobile access network 100 (stage 350), and the integrated gateway and caching node 130 redirecting the UE 80 to the identified caching server (stage 360). The process 300 can include the UE requesting the content data from the identified caching server (stage 370) and receiving the requested content data (stage 380).

The process 300 can include the UE 80 generating and sending a request for content data to the content provider network 90 or device thereof (stage 310). For instance, the data request can be sent to an anycast node associated with the content provider network 90. An application running on the UE 80 (such as a browser application, media player application, gaming application, shopping application, email application, social media application, or the like) can generate a request for content data (such as a web page, video data, audio data, etc.) upon a user of the UE 80 initiating the application or acting upon a displayed interactive tab, icon, link or similar GUI component. The UE 80 can send the generated request via a respective access point 110 of the mobile access network 100 to the content provider network 90. Data packets associated with generated request can be routed through an aggregator gateway 120 to the integrated gateway and caching node 130. The integrated gateway and caching node 130 can process data packets associated with the UE generated data request and determine that the data packets are destined to the mapping service module 92 of the content provider network 90. The integrated gateway and caching node 130 can then forward the data packets to the mapping service module 92.

The process 300 can include the mapping service module 92 redirecting the UE to the integrated gateway and caching node 130 for serving the requested content data (stage 320). For instance, the mapping service module 92 can retrieve from the data packets associated with the received request a respective source IP address. Based on the source IP address, the mapping service module 92 can determine the integrated gateway and caching node 130 serving the UE 80. The mapping service module 92 can then check whether the requested data content is available in a cache associated with the determined integrated gateway and caching node 130. For instance, the mapping service module 92 can maintain or have access to a database (or data structure such as lookup table) including information indicative of content stored in one or more caches associated one or more integrated gateway and caching nodes of the mobile access network 100. In some implementations, the mapping service module 92 can determine an integrated gateway and caching node of the mobile access network different than the one currently serving the UE 80. Upon determining that the requested content data is cached in a caching repository (such as caching repository 91) associated with the integrated gateway and caching node 130, the mapping service module 92 can send redirect request (such as HTTP 302 request) to the UE 80 (stage 320). The redirect request can include an indication (e.g., a request token, an IP address associated with the integrated gateway and caching node 130 or a combination thereof) to cause the UE 80 to send the content data request to the integrated gateway and caching node 130.

The process 300 can include the UE 80 sending the content data request to the integrated gateway and caching node 130 (stage 330). In response to the redirect request received from the mapping service module 92, the UE 80 can send the content data request to the integrated gateway and caching node 130. In some implementations, the request sent to the integrated gateway and caching node 130 can include the request token.

The integrated gateway and caching node 130 can send a request to the mapping service module 92 asking for a caching server (or cache) storing the requested content data (stage 340). In response to the received content data request from the UE 80, the cache control function module 136 can obtain one or more attributes of the mobile access network 100. The attribute(s) can include indication(s) states of one or more communication elements (e.g., aggregator gateway 120 or access point 110) or states of one or more caching server(s) (or cache(s)) deployed in association with the integrated gateway and caching node 130. The integrated gateway and caching node 130 can then send the attribute(s) together with the original request to the mapping service module 92. The integrated gateway and caching node 130 can also send request token to the mapping service module 92. In some implementations, The integrated gateway and caching node 130 can send the attribute(s) and the request token. In such implementations, the mapping service module 92 can identify the request based on the received token. That is, the mapping service module 92 can maintain information associated with the request at stage 310.

In the mobile access network 100, there are many attributes of the network that are normally only visible to network elements of the mobile access network 100. The attributes can include information indicative of network conditions within the mobile network such as congestion information of an access point 110 (or aggregator gateway 120) serving the UE 80 (or links therebetween). The attributes can also include information about a visited network when the UE 80 is roaming connection. These attributes are not visible to the UE 80 and as such are not sent to the mapping service module 92 in typical mobile access networks. By integrating gateway and caching functionalities, the integrated gateway and caching node 130 can make use of such attributes in serving requested content data or provide the attributes to the mapping service module 92.

The process 300 can include the mapping service module 92 responding to the integrated gateway and caching node 130 with a specified caching server (or cache) deployed in the mobile access network 100 for serving the requested content data (stage 350). As discussed above with regard to FIG. 1, the mapping service module 92 can determine a caching server (or cache) associated with the integrated gateway and caching node 130 for serving the requested content data. For instance, the mapping service module 92 can identify caching server(s) associated with the integrated gateway and caching node 130 storing the requested content data. The mapping service module 92 can also check the state of the data stored in the identified caching servers. In case multiple caching servers are identified, the mapping service module 92 can compare the health statuses of the identified caching servers and the quality of service for respective communication links with the UE 80. In general, the mapping service module can be configured to apply mapping policy rules and criteria (e.g., obtained from the mapping policy module 94) to select a caching server for serving the requested content data. In some implementations, the mapping service module 92 can be configured to prioritize caching servers deployed in association with the integrated gateway and caching node 130 over caching servers in the content provider network. Once a caching server is selected, the mapping service module can send an indication (e.g., a respective IP address) of the selected caching server to the integrated gateway and caching node 130.

Upon receiving the indication of the selected caching server (stage 350) from the mapping service module 92, the integrated gateway and caching node 130 can send a redirect request (such as a HTTP 302 redirect request) to the UE 80 (stage 360). The redirect request can include an identification (e.g., IP address) of the selected caching server.

In response to the redirect request received, the UE 80 can send the request for the content data to the selected caching server (stage 370). Data packets associated with the request to the selected caching server can be identified by the packet processing function 135 and passed to the cache control function 136 (e.g., a cache control function associated with the selected caching server). In some implementations, the caching server can obtain network attributes, such as subscriber policy rules associated with UE 80, rules associated with content to be served to the UE 80 or information indicative of network conditions, from the integrated gateway and caching node 130. The caching server can use the network attributes to determine one or more parameters (such as, a bitrate, video or image resolution format, routing path, etc.) according to which the content is to be served to the UE 80. The caching server can then serve the UE 80 with content according to the determined parameter(s). For instance, the caching server may select a routing path for serving the requested content data based on the congestion state of one or more links or network elements of mobile access network 100. In some instances, the caching server may select a coding bitrate for requested video data based on available bandwidth or a prepaid charge associated with the UE 80.

The cache control function module 136, e.g., in cooperation with the cache storage function 138, can retrieve the requested content data and send it to the requesting UE 80 (stage 380). The application of the UE 80 can then process or display the received content.

In some implementations, the integrated gateway and caching node 130 can include (or be coupled to) multiple caching servers. In some implementations, the integrated gateway and caching node 130 can include a local instance of the mapping service module 92′ and/or a local instance of the mapping policy module 94′. In such implementations, the integrated gateway and caching node 130 can determine a local caching server for serving the requested content data (e.g., instead of stages 340 and 350) without initially contacting the mapping service module 92 at the content provider network 90. The integrated gateway and caching node 130 can contact the mapping service module 92 of the content provider network 90 if an attempt to determine a local caching server fails (e.g., local caching server is busy or down).

By integrating policy and charging functionalities (e.g., P-GW or GGSN) with caching functionalities, the integrated gateway and caching node 130 is capable of properly serving secure content data requests (such as HTTPS requests). That is, since content data requests can be handled on the same network element (e.g., a network element associated with the integrated gateway and caching node 130), HTTPS requests can be properly served by data caches deployed within the mobile access network 100. Also, fine grained policies that depend on the content being requested can be handled. For example, if the content being served is video, metadata associated with the video such as genre, popularity, available resolutions and formats can be provided by the cache control function module 136 to the PCEF module 134 and referenced in subscriber policies. Conversely, subscriber policies from the PCEF module 134, like available bandwidth, account balance, or perhaps other demographic information can be used by the cache control function module 136 to select a proper serving action. For example if a prepaid subscriber has a limited account balance, and wanted to watch a longer video, it may be better to select and serve a lower resolution video to limit the bandwidth used. In another aspect, in order for the content network to determine from which cache servers a particular request should be served, a mapping service is used to orchestrate amongst the available cache servers.

Furthermore, by integrating caching with the gateway handling communications with external data networks (such as S-GW or GGSN), no complexity is added to handover processes between distinct access points 110 or aggregator gateways 120. For instance, when the UE 80 moves from one location to another, the respective serving access point or aggregator gateway 120 can change. Accordingly, as the UE 80 moves, the tunnel between the integrated gateway and caching node and the serving access point 110 changes and the UE 80 can continue to be served from the same cache that was serving the UE 80 before moving. However, the IP anchor gateway (such as S-GW or GGSN) for a given session is less like to change.

In some implementations, caching repositories can be arranged at the access points 110 or aggregator gateways 120 so that the cached data is closer to the UE 80. In such implementations, additional handover processes for handling handover between different caching repositories need to be implemented within the access mobile network. That is, a new cache associated with a new access point 110 or aggregator gateway 120 serving the UE after a handover needs to know what portion of the requested data was already delivered to the UE 80. Also, caching repositories deployed in association with an IP anchor gateways can serve more users than caching repositories associated with access points 110 or aggregator gateways 120. Accordingly, caching data in association with IP anchor gateways can be less costly to provider networks.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs embodied on a tangible medium, i.e., one or more modules of computer program instructions, encoded on one or more computer storage media for execution by, or to control the operation of, a data processing apparatus. A computer storage medium can be, or be included in, a computer-readable storage device, a computer-readable storage substrate, a random or serial access memory array or device, or a combination of one or more of them. The computer storage medium can also be, or be included in, one or more separate components or media (e.g., multiple CDs, disks, or other storage devices). The computer storage medium may be tangible and nontransitory.

The operations described in this specification can be implemented as operations performed by a data processing apparatus on data stored on one or more computer-readable storage devices or received from other sources. The processes and logic flows can also be performed by, and apparatus can also be implemented as, special purpose logic circuitry, e.g., an FPGA (field programmable gate array) or an ASIC (application specific integrated circuit).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

References to “or” may be construed as inclusive so that any terms described using “or” may indicate any of a single, more than one, and all of the described terms. The labels “first,” “second,” “third,” and so forth are not necessarily meant to indicate an ordering and are generally used merely to distinguish between like or similar items or elements.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

What is claimed is:

1. An apparatus arranged within a mobile access network for handling connections with a content provider network and for managing access to data cache associated with the content provider network and deployed within the mobile access network, the apparatus comprising:
at least one processor; and
at least one memory storing computer code instructions, the computer code instructions when executed by the at least one processor causes the apparatus to:
receive a request for data associated with the provider network, the request associated with a client device in communication with the mobile access network;
obtain at least one attribute of the mobile access network;
determine a caching server deployed in the mobile access network for serving the request for data, the caching server determined based on information associated with the request and the at least one attribute; and
redirect the client device to the determined caching server.

2. The apparatus of claim 1, wherein determining a caching server includes:
sending an indication of the request and the at least one attribute to a computer device associated with the content provider network; and
receiving an indication of the caching server from the computer device associated with the content provider network.

3. The apparatus of claim 2, wherein the computer device associated with the content provider network includes a policy mapping module configured to identify the caching server based on the indication of the request and the at least one attribute associated with the mobile access network.

4. The apparatus of claim 3, wherein the policy mapping module is further configured to identify the caching server based on at least one of a caching server state or a caching server capacity for one or more caching servers.

5. The apparatus of claim 1, wherein the at least one attribute includes at least one of:
an indication of one or more available communication paths for carrying the requested data to the client device; or
at least one quality of service parameter associated with a communication path for carrying the requested data to the client device.

6. The apparatus of claim 5, wherein the at least one quality of service parameter includes an indication of at least one of a bandwidth, latency, packet drop rate or access point congestion state.

7. The apparatus of claim 1, wherein redirecting the client device to the determined caching server includes sending a message including an identification of the determined caching server to the client device.

8. A method for managing data associated with a content provider network cached within a mobile access network, the method comprising:
receiving, by an integrated gateway and caching node of the mobile access network, a request for data generated by a client device in communication with the mobile access network, the integrated gateway and caching node configured to handle communications with content provider networks and manage content provider data cached in the mobile access network;
obtaining at least one communication attribute associated with the mobile access network;
determining a caching server deployed in the mobile access network for serving requested data to the client device, the caching server determined based on information associated with the request and the at least one attribute; and
redirecting the client device to the determined caching server.

9. A computer-readable medium including computer code instructions stored thereon, the computer code instructions when executed by a processor perform a method for managing data associated with a content provider network and cached within a mobile access network, the method comprising:
receiving, at an integrated gateway and caching node of the mobile access network, a request for data generated by a client device in communication with the mobile access network, the integrated gateway and caching node configured to handle communications with content provider networks and manage content provider data cached in the mobile access network;
obtaining at least one communication attribute associated with the mobile access network;
determining a caching server deployed in the mobile access network for serving requested data to the client device, the caching server determined based on information associated with the request and the at least one attribute; and
redirecting the client device to the determined caching server.

10. An apparatus for managing access to data associated with a content provider network, comprising:
at least one processor; and
at least one memory storing computer code instructions, the computer code instructions when executed by the at least one processor causes the apparatus to:
receive a request, from a client device, for data associated with the provider network through a mobile access network;
determine based on information associated with the request a network node of the mobile access network associated with a data cache storing the requested data, the network node configured to handle communications between mobile access network and the content provider network and to manage access to data associated with the content provider network cached within the mobile access network;
redirect the client device to the network node;
receive a caching server request, from the network node, for a caching server to serve the requested data, the caching server request includes at least one attribute of the mobile access network;
determine a caching server deployed in the mobile access network for serving the request for data, the caching server determined based on information associated with the request and the at least one attribute; and
send an indication of the caching server to the network node.

11. The apparatus of claim 10, wherein the apparatus includes a policy mapping module configured to identify the caching server based on the indication of the request and the at least one attribute associated with the mobile access network.

12. The apparatus of claim 11, wherein the policy mapping module is further configured to identify the caching server based on at least one of a caching server state or a caching server capacity for one or more caching servers.

13. The apparatus of claim 10, wherein the at least one attribute includes at least one of:
an indication of one or more available communication paths for carrying the requested data to the client device; or
at least one quality of service parameter associated with a communication path for carrying the requested data to the client device.

14. The apparatus of claim 13, wherein the at least one quality of service parameter includes an indication of at least one of a bandwidth, latency, packet drop rate, or access point congestion state.

15. The apparatus of claim 10, wherein the indication of the caching server includes an Internet protocol (IP) address of the caching server.

16. The apparatus of claim 10, wherein redirecting the client device includes sending a message to the client device including a token of the request.

17. A method for managing access to data associated with a content provider network, the method comprising:
receiving, by an electronic device associated with a content provider network, a request from a client device for data associated with the provider network through a mobile access network;
determining, by the electronic device associated with a content provider network, based on information associated with the request a network node of the mobile access network associated with a data cache storing the requested data, the network node configured to handle communications between mobile access network and the content provider network and to manage access to data associated with the content provider network cached within the mobile access network;
redirecting, by the electronic device associated with a content provider network, the client device to the network node;
receiving, by the electronic device associated with a content provider network, a caching server request, from the network node, for a caching server to serve the requested data, the caching server request includes at least one attribute of the mobile access network;
determining, by the electronic device associated with a content provider network, a caching server deployed in the mobile access network for serving the request for data, the caching server determined based on information associated with the request and the at least one attribute; and
sending, by the electronic device associated with a content provider network, an indication of the caching server to the network node.

18. A computer-readable medium including computer code instructions stored thereon, the computer code instructions when executed by a processor perform a method for managing data associated with a content provider network and cached within a mobile access network, the method comprising:
receiving, at an electronic device associated with a content provider network, a request from a client device for data associated with the provider network through a mobile access network;
determining, based on information associated with the request, a network node of the mobile access network associated with a data cache storing the requested data, the network node configured to handle communications between the mobile access network and the content provider network and to manage access to data associated with the content provider network cached within the mobile access network;
redirecting the client device to the network node;
receiving, from the network node, a caching server request for a caching server to serve the requested data, wherein the caching server request includes at least one attribute of the mobile access network;
determining a caching server deployed in the mobile access network for serving the request for data, the caching server determined based on information associated with the request and the at least one attribute; and
sending an indication of the caching server to the network node.
